(19) United States
(12) Patent Application Publication
(10) Pub. No.: US 2010/0066654 A1
(43) Pub. Date: Mar. 18, 2010

(54) THREE-DIMENSIONAL DISPLAY DEVICE

(75) Inventors: Yi-Pai Huang, Chiayi City (TW); Ching-Yi Hsu, Taipei County (TW); Yu-Chen Chang, Taichung County (TW); Chih-Ping Su, Keelung City (TW); Chia-Lin Liu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taoyuan (TW)

(21) Appl. No.: 12/270,835

(22) Filed: Nov. 13, 2008

(30) Foreign Application Priority Data
Sep. 12, 2008 (TW) 97135251

(51) Int. Cl. G09G 3/32

(52) U.S. Cl. 345/82

(57) ABSTRACT

A three-dimensional display device including a collimated backlight module, a first display panel, a second display panel, and a lens array is provided. The collimated backlight module has a light-emitting surface and provides a light with a divergent angle smaller than 10° from the light-emitting surface. The first display panel having a plurality of first pixels is disposed on the collimated backlight module. The second display panel has a plurality of second pixels corresponding to the first pixels. The first display panel is disposed between the second display panel and the collimated backlight module. A depth distance is formed between the first display panel and the second display panel. The lens array is disposed adjacent to the second display panel and has a plurality of lenses corresponding to the second pixels. Therefore, the three-dimensional display device is capable of providing a wide visual angle and desirable depth characteristics.

### CROSS-REFERENCE TO RELATED APPLICATION

This application claims the priority benefit of Taiwan application serial no. 97135251, filed on Sep. 12, 2008. The entirety of the above-mentioned patent application is hereby incorporated by reference herein and made a part of this specification.

### BACKGROUND OF THE INVENTION

1. Field of the Invention

The present invention generally relates to a display device, in particular, to a three-dimensional display device.

2. Description of Related Art

With the progress and development of technologies, the mass always has an increasingly high requirement on the enjoyment in both material and mental lives, which is never reduced. In terms of the mental enjoyment, as the technologies have been progressed rapidly with each passing day, people hope that they can realize their boundless imaginations through a three-dimensional display device, so as to achieve a feeling of being personally involved on the scene. Therefore, it becomes an objective urgently achieved in the current three-dimensional display technologies to enable three-dimensional display devices to show three-dimensional pictures or images.

As for the current display technologies, three-dimensional display technologies are mainly classified into a stereoscopic type requiring a viewer to wear a pair of special glasses and an auto-stereoscopic type for viewing directly with naked eyes. The stereoscopic three-dimensional display technology has been developed to be mature and widely applied to some special fields such as military simulation or large-scale recreations, but the stereoscopic three-dimensional display technology is difficult to be popularized due to its inconvenient and discomfort features. Therefore, the auto-stereoscopic three-dimensional display technology has gradually developed and become a new trend.

In a conventional three-dimensional display device, a fixed grating is disposed in front of a liquid crystal display (LCD) panel to enable a viewer to watch images corresponding to the display image with a left eye and a right eye respectively. It should be noted that, when the fixed grating is taken as a three-dimensional image processing mechanism, it belongs to a spatial-multiplexed manner since the image watched by the viewer is obtained by dividing the display image into a left-eye image display area and a right-eye image display area. Although the three-dimensional display effect of the LCD panel can be achieved, the resolution of the three-dimensional display device is greatly reduced.

FIGS. 1A to 1C are schematic views of a conventional three-dimensional display device. Referring to FIGS. 1A and 1B, a three-dimensional display device 100 includes a first LCD panel 110, a second LCD panel 120, and a backlight module 130. A depth distance D is formed between the first LCD panel 110 and the second LCD panel 120. The first LCD panel 110 has a plurality of first pixels 112. The first pixels 112 are arranged corresponding to second pixels 122 on the second LCD panel 120.

As shown in FIGS. 1A and 1B, the first pixels 112A, 112B, and 112C on the first LCD panel 110 respectively correspond to the second pixels 122A, 122B, and 122C on the second LCD panel 120. Based on the optical illusion principle, by means of changing the relative brightness of the first pixels 112 and the second pixels 122, a viewer is enabled to see an image with different depths. Such a technology is generally referred to as a Depth-Fused 3D (DFD) image technology. As shown in FIG. 1A, the first pixel 112A has higher brightness than the second pixel 122A, so an image at this position viewed by the viewer has a higher depth. Likewise, the first pixel 112C has lower brightness than the second pixel 122C, so an image at this position viewed by the viewer has a smaller depth.

The DFD image technology can eliminate the inconveniences caused by wearing a pair of glasses when the viewer views a three-dimensional image. However. as shown in FIG. 1A, the viewer must view the pixels on the three-dimensional display device from the front, otherwise, an offset occurs to the corresponding first pixels 112 and second pixels 122 due to a variation in the viewing angle. As shown in FIG. 1B, when the viewer views the image at a large visual angle, the first pixel 112A corresponds to the second pixel 122B, and the first pixel 112B corresponds to the second pixel 122C. As a result, the viewer cannot enjoy the desired three-dimensional image effect.

On the other aspect, as shown in FIG. 1C, the backlight module 130 for providing a light for the LCD panels has a light-emitting surface 130E. Since the lights provided by the backlight module are emitted from the light-emitting surface 13GE at different angles, the lights have a large divergent angle, and as a result, the normal image that should be seen by the viewer is affected by an image overlapping problem. In particular, the lights La, Lb, and Lc in three different travel directions provided by the backlight module 130 pass through the first LCD panel 110 and the second LCD panel 120. However, the angles of the light-emitting La, Lb, and Lc are significantly different from each other, the light La passing through the second pixel 122A passes through the first pixel 112B and thus is seen by the viewer. On the other hand, the light Lc passing through the second pixel 122C also passes through the first pixel 112B and thus is seen by the viewer. Therefore, besides the light Lb passing through the second pixel 122B and the first pixel 112B, the image seen by the viewer is also affected by neighboring pixels, thereby resulting in image overlapping or interference problems.

In order to avoid the above image overlapping or interference problems, one way is to reduce the distance between the first LCD panel 110 and the second LCD panel 120. However, as the distance between the first LCD panel 110 and the second LCD panel 120 is reduced, the depth distance is reduced accordingly, thereby affecting the display quality of the three-dimensional image. Therefore, as for the three-dimensional display device employing the DFD image technology, it has become an important issue to solve the visual angle problem and increase the depth distance of the three-dimensional display devices.

### SUMMARY OF THE INVENTION

Accordingly, the present invention is directed to a three-dimensional display device, which is suitable for providing a wide visual angle and desirable depth characteristics.

As embodied and broadly described herein, the present invention provides a three-dimensional display device, which includes a collimated backlight module, a first display panel, a second display panel, and a lens array. The collimated backlight module has a light-emitting surface and provides a light with a divergent angle smaller than 10° from the light-emitting surface. The first display panel having a plurality of first pixels is disposed on the collimated backlight module. The second display panel has a plurality of second pixels corresponding to the first pixels. The first display panel is disposed between the second display panel and the collimated backlight module. A depth distance is formed between the first display panel and the second display panel. The lens array is disposed adjacent to the second display panel and has a plurality of lenses corresponding to the second pixels.

In an embodiment of the present invention, the lens array is connected to one side of the second display panel adjacent to the first display panel, or connected to one side of the second display panel far away from the first display panel.

In an embodiment of the present invention, the divergent angle is a difference of a maximum included angle between the light and the light-emitting surface with respect to a minimum included angle between the light and the light-emitting surface.

In an embodiment of the present invention, the first display panel includes a first thin-film transistor array substrate, a first color filter substrate, and a first liquid crystal layer. The first thin-film transistor array substrate is disposed on the light-emitting surface and located between the first color filter substrate and the collimated backlight module. The first liquid crystal layer is located between the first thin-film transistor array substrate and the first color filter substrate.

In an embodiment of the present invention, the second display panel includes a second thin-film transistor array substrate, a second color filter substrate, and a second liquid crystal layer. The second thin-film transistor array substrate is adjacent to the first display panel and located between the second color filter substrate and the first display panel. The second liquid crystal layer is located between the second thin-film transistor array substrate and the second color filter substrate. In this case, the lens array may be connected to one side of the second thin-film transistor array substrate far away from the second liquid crystal layer, and may also be connected to one side of the second color filter substrate far away from the second liquid crystal layer.

In an embodiment of the present invention, the depth distance is substantially 0.5 cm to 20 cm.

In an embodiment of the present invention, the depth distance is substantially 3 cm.

In an embodiment of the present invention, the lenses are convex lenses, and a curvature radius of each of the convex lenses is respectively, for example, ½ of a size of each of the second pixels.

In an embodiment of the present invention, each of the lenses is correspondingly disposed on each of the second pixels.

In an embodiment of the present invention, a cross-sectional area of each of the lenses is substantially equal to an area of each of the second pixels.

In an embodiment of the present invention, each of the lenses is correspondingly disposed on a column of pixels among the second pixels.

In an embodiment of the present invention, the cross-sectional area of each of the lenses is substantially equal to an area of the column of pixels among the second pixels.

In an embodiment of the present invention, each of the lenses is correspondingly disposed on a row of pixels among the second pixels.

In an embodiment of the present invention, each of the lenses is correspondingly disposed on the second pixels around the second display panel.

In view of the above, the present invention utilizes the collimated backlight module to provide a highly-collimated light, so as to effectively reduce the probability of mutual interferences caused by the light provided by a conventional backlight module module, thereby avoiding the image overlapping problem in the prior art. Moreover, through combining the three-dimensional display device of the present invention with a suitable lens array, the visual angle of the three-dimensional display device can be widened.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1C are schematic views of a conventional three-dimensional display device.

FIGS. 2A and 2B are schematic cross-sectional views of a three-dimensional display device according to an embodiment of the present invention.

FIG. 3A is a cross-sectional view of the three-dimensional display device of FIG. 2A.

FIG. 3B is a schematic cross-sectional view of a three-dimensional display device according to the present invention.

FIG. 4A is a top view of a configuration status of a lens array in a three-dimensional display device according to the present invention.

FIG. 4B is a top view of a configuration status of a lens array in a three-dimensional display device according to the present invention.

FIG. 4C is a top view of a configuration status of a lens array in a three-dimensional display device according to the present invention.

FIG. 4D is a top view of a configuration status of a lens array in a three-dimensional display device according to the present invention.

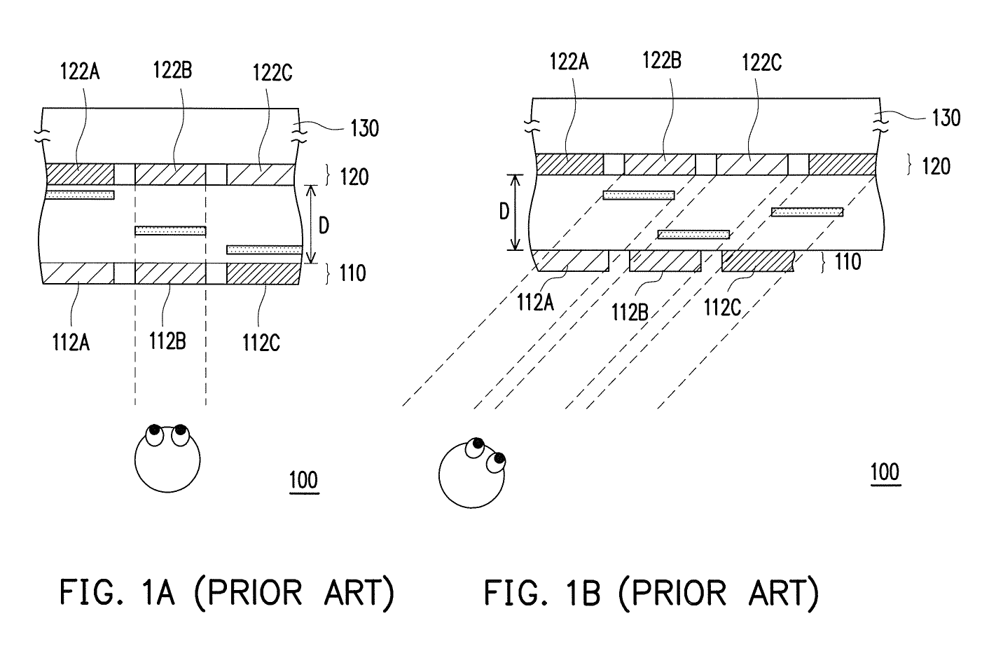

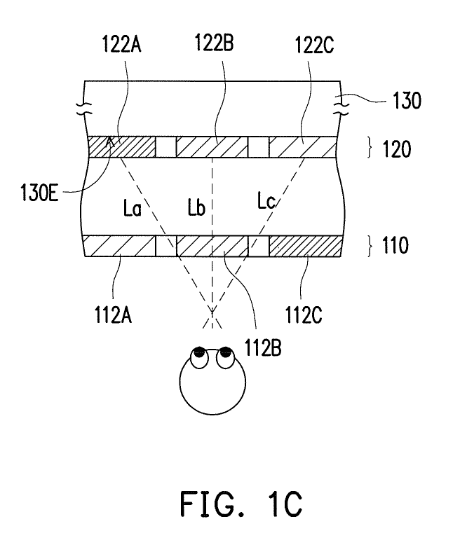

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

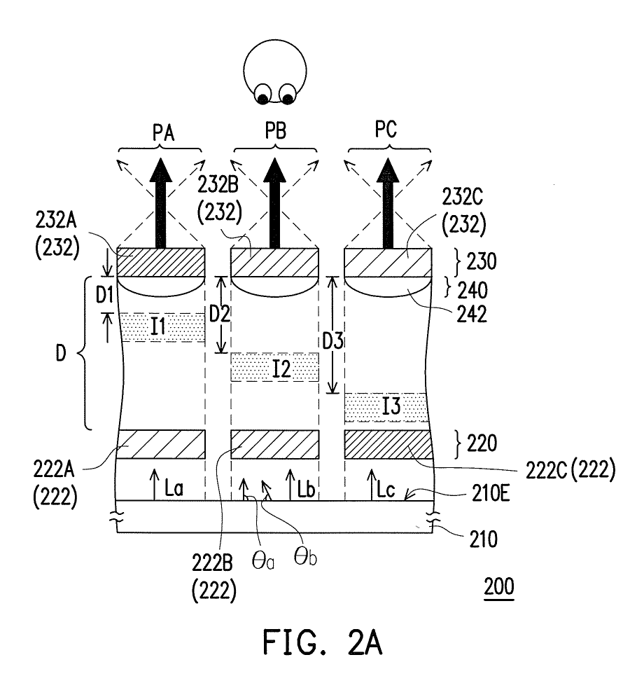

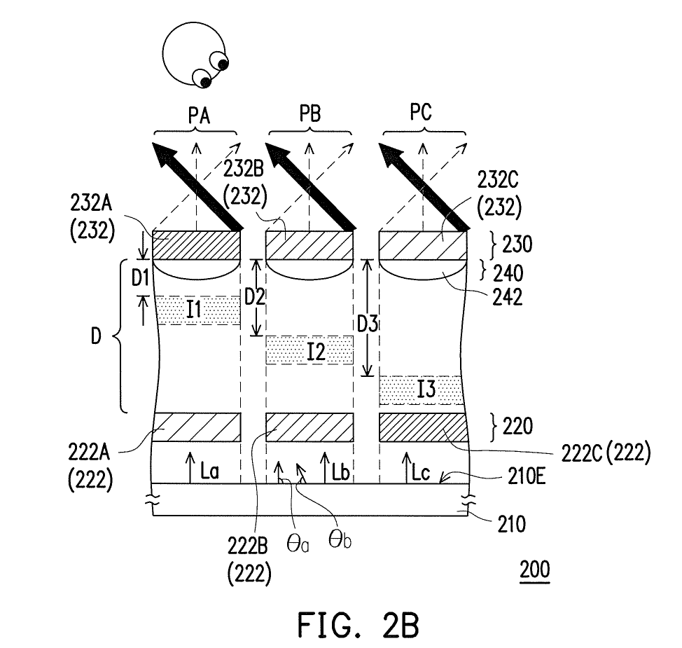

FIGS. 2A and 2B are schematic cross-sectional views of a three-dimensional display device according to an embodiment of the present invention. Referring to FIGS. 2A and 2B, a three-dimensional display device 200 includes a collimated backlight module 210, a first display panel 220, a second display panel 230, and a lens array 240. The collimated backlight module 210 has a light-emitting surface 210E and provides a light with a divergent angle smaller than 10° from the light-emitting surface 210E (which is described below). The first display panel 220 having a plurality of first pixels 222 is disposed on the collimated backlight module 210. The second display panel 230 has a plurality of second pixels 232 corresponding to the first pixels 222. The first display panel 220 is disposed between the second display panel 230 and the collimated backlight module 210. A depth distance D is formed between the first display panel 220 and the second display panel 230. The lens array 240 is disposed adjacent to the second display panel 230 and has a plurality of lenses corresponding to the second pixels 232. The lenses are, for example, convex lenses.

As shown in FIGS. 2A and 2B, since brightness of the first pixels 222 and brightness of the corresponding second pixels 232 have different brightness ratios, a viewer has different depth viewing feelings on a viewed image, thereby achieving a three-dimensional effect of different depths on the viewed image. For example, the first pixel 222A on the left of the figure has higher brightness than the second pixel 232A, and an image I1 presented in a pixel area PA has a depth value of D1. The first pixel 222B has the brightness approximately the same as the corresponding second pixel 232B, and an image I2 presented in a pixel area PB has a depth value of D2. The first pixel 222C has lower brightness than the corresponding second pixel 232C, and an image I3 presented in a pixel area PC has a depth value of D3, and D1<D2<D3. Therefore, the viewer can see a three-dimensional image with different depths.

It should be noted that the collimated backlight module 210 is used to provide a highly-collimated light. That is, although the travel directions of the light are slightly different, the angle difference between the light in different travel directions is maintained smaller than 10°. For example, as shown in FIG. 2A, in this embodiment, it is assumed that a maximum included angle between the light and the light-emitting surface 210E is θₐ and a minimum included angle between the light and the light-emitting surface 210E is θ_{b}, and a divergent angle θ satisfies the following expression: θ=θₐ−θ_{b}<10°.

Hence, the light provided by the collimated backlight module 210 of the present invention is highly collimated, so that the light passing through neighboring pixel areas P is unlikely to interfere with each other. For example, the light La and the light Lc in FIG. 2A are not easily incident to the pixel area PB, so that the image I2 displayed in the pixel area PB is less likely to be interfered by the light La and the light Lc, thereby effectively avoiding the conventional image overlapping and interference problems of the three-dimensional display device 200. Since the collimated backlight module 210 of the present invention provides a highly-collimated light, the depth distance D can be increased depending on the design requirements or users' requirements, so as to further improve the three-dimensional effects of the image displayed by the three-dimensional display device 200. In this embodiment, the depth distance D is substantially, for example, 0.5 cm to 20 cm. In an embodiment, the depth distance D is substantially 3 cm.

On the other aspect, the lens array 240 is disposed on the second display panel 230 in the present invention. As shown in FIG. 2A, the lens array 240 is directly connected to one side of the second display panel 230 adjacent to the first display panel 220. Lenses 242 on the lens array 240 are operated together with the corresponding second pixels 232, so as to enable the light incident to the second pixels 232 to be deflected for a large angle after passing through the lenses 242 and then emitted from the second pixels 232.

In particular, as shown in FIG. 2B, after the light provided by the collimated backlight module 210 to the second pixels 232 is refracted by the lenses 242, the viewer can see the image displayed by the three-dimensional display device 200 in a large angle, and thus the visual angle is widened. Therefore, as for a three-dimensional display device 200 with a large screen or requiring a wide visual angle, the wide visual angle effect can be achieved for the three-dimensional display device 200 through using the lens array 240 in the present invention, thereby improving the quality of the three-dimensional displaying effect. Moreover, a refracting surface of each convex lens 242 is, for example, an arc surface. In this embodiment, a curvature radius of each convex lens 242 is, for example, ½ of a size of each second pixel 232. That is, when each convex lens 242 is in a semi-cylindrical shape, the convex lens 242 is attached within a projection range of the corresponding second pixel 232 along a diameter thereof.

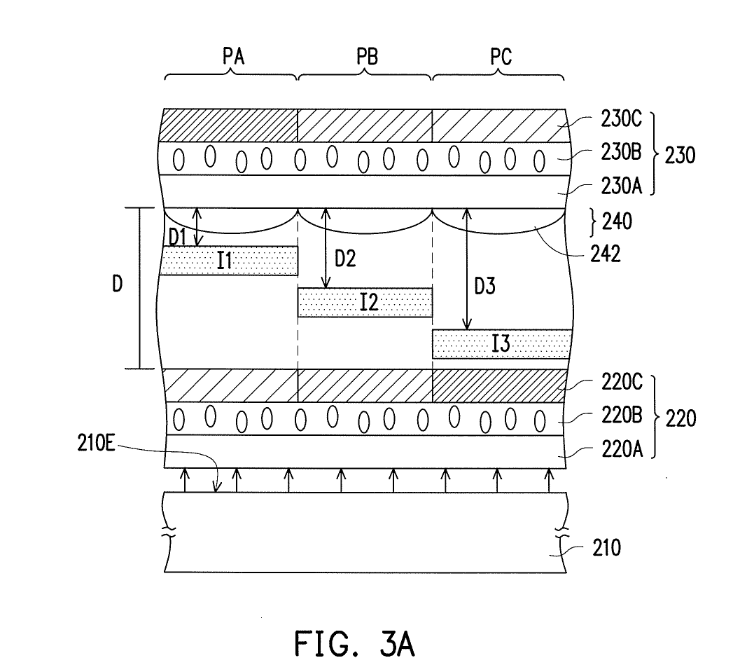

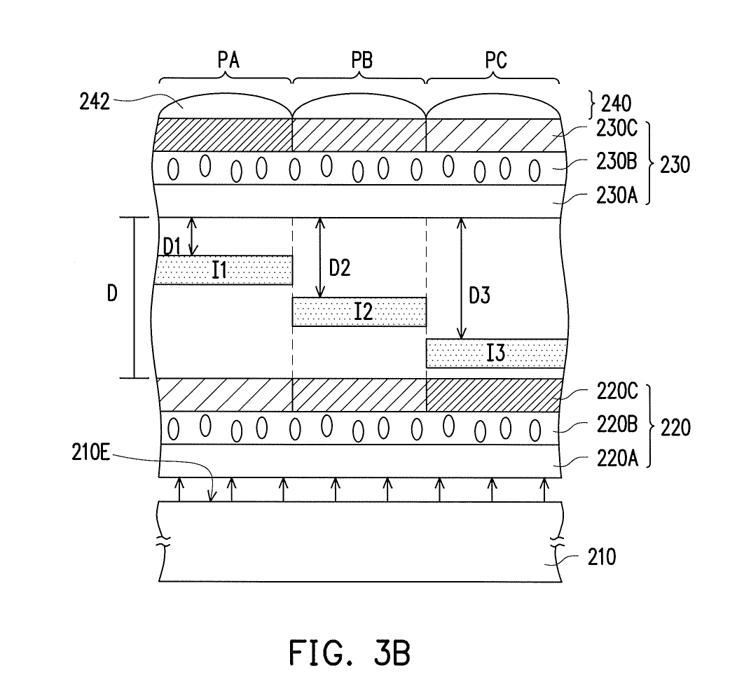

In particular, such lens array 240 may be formed through a laser etching process or molding technology, but the present invention is not limited here. Particularly, FIG. 3A is a cross-sectional view of the three-dimensional display device of FIG. 2A. Referring to FIG. 3A, the first display panel 220 includes, for example, a first thin-film transistor array substrate 220A, a first color filter substrate 220C, and a first liquid crystal layer 220B. The first thin-film transistor array substrate 220A is disposed on the light-emitting surface 210E and located between the first color filter substrate 220C and the collimated backlight module 210. The first liquid crystal layer 220B is located between the first thin-film transistor array substrate 220A and the first color filter substrate 220C. In addition, the second display panel 230 includes a second thin-film transistor array substrate 230A, a second color filter substrate 230C, and a second liquid crystal layer 230B. The second thin-film transistor array substrate 230A is adjacent to the first display panel 220 and located between the second color filter substrate 230C and the first display panel 220. The second liquid crystal layer 230B is located between the second thin-film transistor array substrate 230A and the second color filter substrate 230C. In this embodiment, the lens array 240 is directly connected to one side of the second thin-film transistor array substrate 230A far away from the second liquid crystal layer 230B.

FIG. 3B is a schematic cross-sectional view of a three-dimensional display device according to the present invention. Referring to FIG. 3B, for the ease of description, the components similar to those of FIG. 3A are not described herein again. As compared with FIG. 3A, the lens array 240 in the three-dimensional display device 200 of this embodiment is directly connected to one side of the second color filter substrate far away from the second liquid crystal layer 230B.

In terms of the applications of the three-dimensional display device 200, the lens array 240 may be correspondingly disposed in a suitable area in the three-dimensional display device 200 depending upon the product size, product operating environment, resolution requirements, pixel size, and other requirements. Moreover, the lenses 242 on the lens array 240 may also vary in size depending on sizes of the pixel areas. Practical applications of the lens array 240 in the three-dimensional display device 200 of the present invention are described below through some embodiments. It should be noted that, the pixel areas in the three-dimensional display device 200 of the present invention are suitable for presenting an image effect with the representation of the first pixels 222 overlapping the representation of the second pixels 232 in the pixel areas.

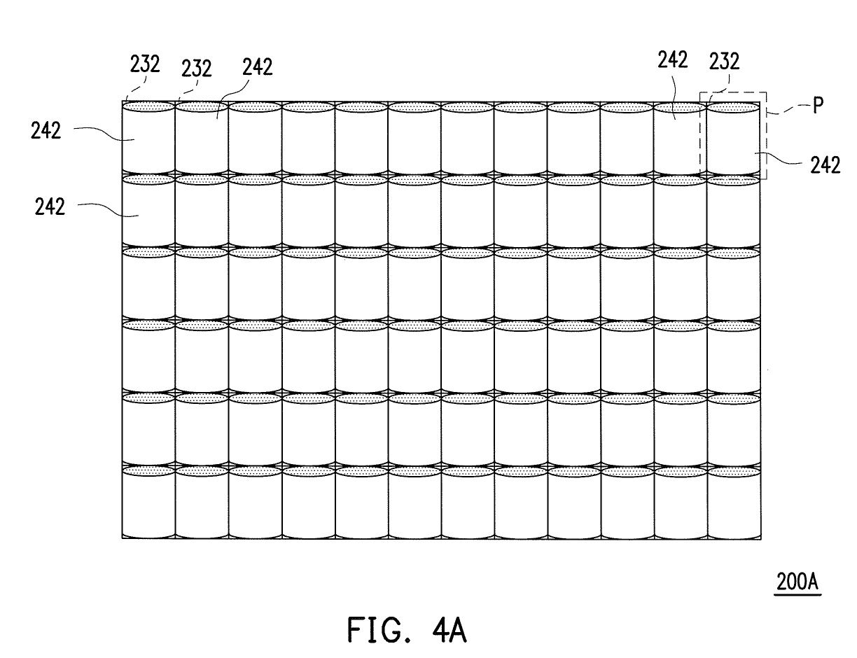

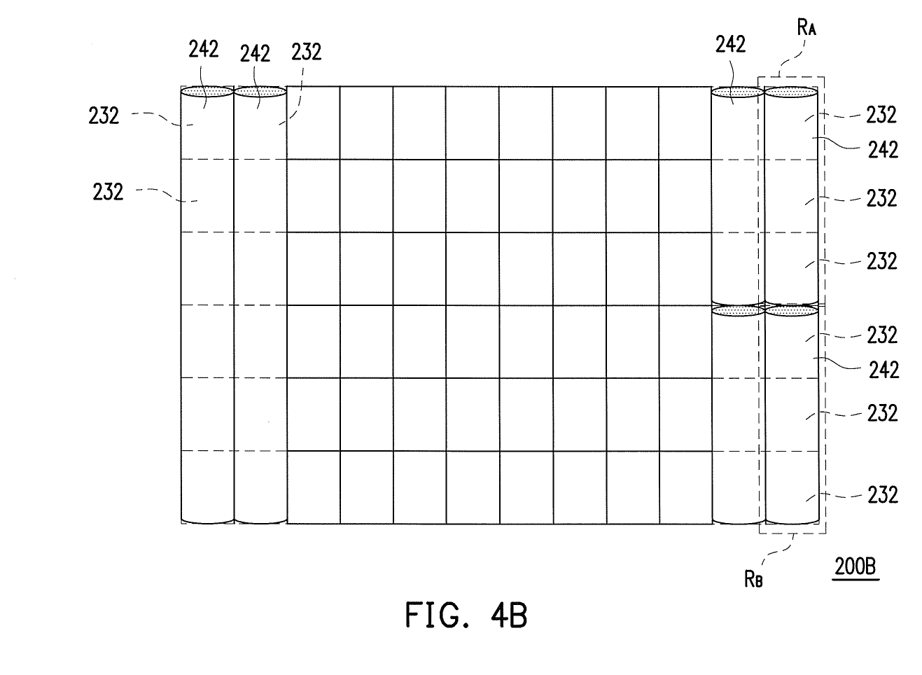

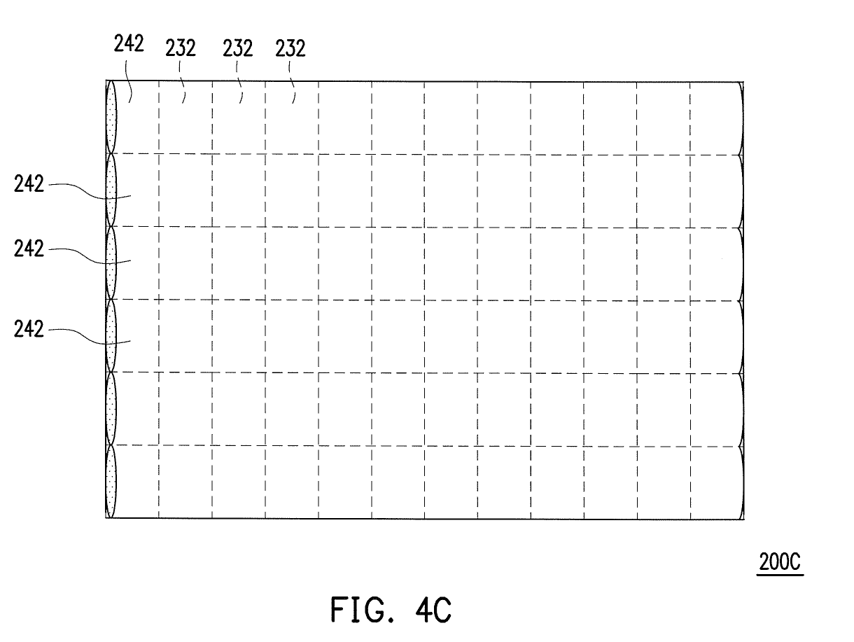

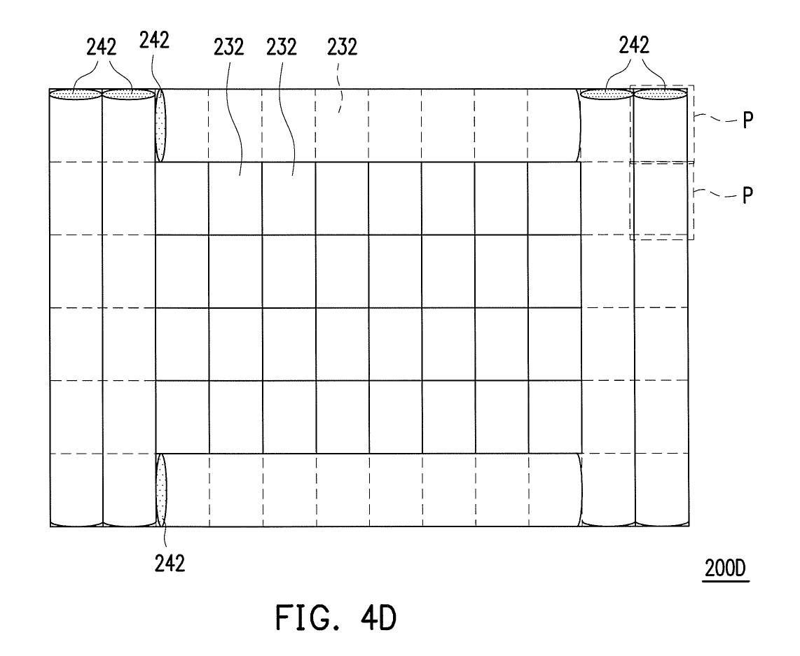

FIG. 4A is a top view of a configuration status of a lens array in a three-dimensional display device according to the present invention. Referring to FIG. 4A, each lens 242 in a three-dimensional display device 200A is correspondingly disposed within a projection area of each second pixel 232. In this embodiment, a cross-sectional area of each lens 242 on the second pixel 232 is substantially equal to an area of each second pixel 232. It should be noted that, in order to describe clearly, FIG. 4A merely shows a relative relation between the lenses 242 on the lens array 240 and the second pixels 232 on the second display panel 230, and the other components are not depicted. As shown in FIG. 4A, each lens 242 enables the light of the corresponding pixel area P to have a large deflection angle when being emitted from the three-dimensional display device 200A, thereby achieving a wide visual angle purpose. Definitely, as described above, each lens 242 may be directly connected to the second color filter substrate 230C, and may also be directly connected to the second thin-film transistor array substrate 230A (shown in FIGS. 3A and 3B), but the present invention is not limited here.

FIG. 4B is a top view of a configuration status of a lens array in a three-dimensional display device according to the present invention. Referring to FIGS. 4B and 3A, considering the manufacturing process and manufacturing cost of the lens array 240, the lens array 240 may also be configured as shown in FIG. 4B. In a three-dimensional display device 200B, the lens array 240 is only appropriately designed on two columns of pixels at each side of the three-dimensional display device 200B, and the lenses 242 may vary in size. For example, each lens 242 may be correspondingly disposed on two columns of second pixels 232 on the left of FIG. 4B, and the cross-sectional area of each lens 242 is substantially equal to an area of a column of pixels among the second pixels 232. Moreover, each lens 242 may also be correspondingly disposed on the corresponding second pixel 232 in a form of two columns of pixels as shown on the right of FIG. 4B. In this case, one column of pixels among the second pixels 232 is mainly divided into two areas R_{A} and R_{B}, and two lenses 242 are correspondingly configured for this column of pixels among the second pixels 232. At this time, the total cross-sectional area of the two lenses 242 on the same column of pixels is approximately equal to the total area of this column of pixels. Definitely, one column of pixels among the second pixels 232 may also be divided into three, four, or more areas, and each lens 242 is correspondingly disposed within each divided area, in which the number of the lenses 242 to be disposed in each column of pixels is not limited in the present invention.

FIG. 4C is a top view of a configuration status of a lens array in a three-dimensional display device according to the present invention. Referring to FIG. 4C, in a three-dimensional display device 200C, each lens 242 may be correspondingly disposed on a row of pixels among the second pixels 232. In this embodiment, the cross-sectional area of each lens 242 is substantially equal to an area of the row of pixels among the second pixels 232.

FIG. 4D is a top view of a configuration status of a lens array in a three-dimensional display device according to the present invention. Referring to FIG. 4D, in practice, since the viewer does not easily see an image displayed at peripheral pixel areas P in a three-dimensional display device 200D, in this embodiment, each lens 242 may be selectively disposed within the projection ranges of the peripheral pixels. In such a manner, the three-dimensional display device 200D of this embodiment can achieve the wide visual angle effect in the most economical way. Moreover, referring to FIGS. 4A to 4D, the lenses 242 are, for example, in a semi-cylindrical shape. However, the lenses 242 may also be configured in a spherical shape or in other suitable shapes, and the shape of the lenses 242 is not limited in the present invention.

To sum up, the three-dimensional display device of the present invention at least has one, some, or all of the following advantages.

1. Through adopting the collimated backlight module in the three-dimensional display device of the present invention, the image overlapping problem of neighboring pixels in the prior art is able to be effectively avoided and the depth distance is able to be increased, thereby improving the displaying quality of the three-dimensional display device.

2. Through using the lens array, the visual angle of the three-dimensional display device of the present invention can be widened, thereby achieving the wide visual angle effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional display device, comprising:
a collimated backlight module, comprising a light-emitting surface, wherein the collimated backlight module provides a light with a divergent angle smaller than 10° from the light-emitting surface;
a first display panel, comprising a plurality of first pixels and disposed on the collimated backlight module;
a second display panel, comprising a plurality of second pixels corresponding to the first pixels, wherein the first display panel is disposed between the second display panel and the collimated backlight module, and a depth distance is formed between the first display panel and the second display panel; and
a lens array, disposed adjacent to the second display panel and comprising a plurality of lenses corresponding to the second pixels.

2. The three-dimensional display device according to claim 1, wherein the lens array is connected to one side of the second display panel adjacent to the first display panel, or connected to one side of the second display panel far away from the first display panel.

3. The three-dimensional display device according to claim 1, wherein the divergent angle is a difference of a maximum included angle between the light and the light-emitting surface with respect to a minimum included angle between the light and the light-emitting surface.

4. The three-dimensional display device according to claim 1, wherein the first display panel comprises:
a first thin-film transistor array substrate, disposed on the light-emitting surface;
a first color filter substrate, wherein the first thin-film transistor array substrate is located between the first color filter substrate and the collimated backlight module; and
a first liquid crystal layer, located between the first thin-film transistor array substrate and the first color filter substrate.

5. The three-dimensional display device according to claim 1, wherein the second display panel comprises:
a second thin-film transistor array substrate, adjacent to the first display panel;
a second color filter substrate, wherein the second thin-film transistor array substrate is located between the second color filter substrate and the first display panel; and
a second liquid crystal layer, located between the second thin-film transistor array substrate and the second color filter substrate.

6. The three-dimensional display device according to claim 5, wherein the lens array is connected to one side of the second thin-film transistor array substrate far away from the second liquid crystal layer.

7. The three-dimensional display device according to claim 5, wherein the lens array is connected to one side of the second color filter substrate far away from the second liquid crystal layer.

8. The three-dimensional display device according to claim 1, wherein the depth distance is substantially 0.5 cm to 20 cm.

9. The three-dimensional display device according to claim 1, wherein the depth distance is substantially 3 cm.

10. The three-dimensional display device according to claim 1, wherein the lenses are convex lenses.

11. The three-dimensional display device according to claim 10, wherein a curvature radius of each of the convex lenses is respectively ½ of a size of each of the second pixels.

12. The three-dimensional display device according to claim 1, wherein each of the lenses is correspondingly disposed on each of the second pixels.

13. The three-dimensional display device according to claim 1, wherein a cross-sectional area of each of the lenses is substantially equal to an area of each of the second pixels.

14. The three-dimensional display device according to claim 1, wherein each of the lenses is correspondingly disposed on a column of pixels among the second pixels.

15. The three-dimensional display device according to claim 1, wherein a cross-sectional area of each of the lenses is substantially equal to an area of the column of pixels among the second pixels.

16. The three-dimensional display device according to claim 1, wherein each of the lenses is correspondingly disposed on a row of pixels among the second pixels.

17. The three-dimensional display device according to claim 1, wherein each of the lenses is correspondingly disposed on the second pixels around the second display panel.
